(19) United States
(12) Patent Application Publication
(10) Pub. No.: US 2011/0052213 A1
(43) Pub. Date: Mar. 3, 2011

(54) METHOD, APPARATUS AND SYSTEM FOR REDIRECTING INFRARED CONTROL CODES OVER A NETWORK FOR CONTROL AND PROCESSING

(75) Inventors: Gregory Herlein, San Francisco, CA (US); Kyoji Oishi, Hyogo (JP)

(73) Assignee: Thomson Licensing LLC, Princeton, NJ (US)

(21) Appl. No.: 12/735,412

(22) PCT Filed: Jun. 10, 2008
(86) PCT No.: PCT/US2008/007249

§ 371 Date: Jul. 14, 2010

Related U.S. Application Data
(60) Provisional application No. 61/062,734, filed on Jan. 29, 2008.

(51) Int. Cl. H04B 10/06

(52) U.S. Cl. 398/202

(57) ABSTRACT

A networked bypass controller of the present invention receives IR codes transmitted from an IR transmitter (often a handheld device) and the controller is configured to either process the IR codes normally, or to perform actions, such as translation or association of the codes with stored function commands, on the IR codes transmitted. The networked bypass controller of the present invention can then send the resulting commands to one or more playout devices over a network to a device controller(s) for causing a response/change in an associated device(s).

### FIELD OF THE INVENTION

The present invention generally relates to device control and programming and, more particularly, to a method, apparatus and system for controlling networked devices using non-specific IR remote control codes.

### BACKGROUND OF THE INVENTION

In a content presentation environment, an infrared (IR) remote is a convenient controller for interacting with and controlling the components for presenting content. For example, in a home theater environment, many units of equipment are integrated into a cohesive system. Similarly, in a retail environment an IR remote is a convenient controller to interact with a plurality of display devices such as a wall of displays used for advertisement (e.g., a TV Wall). However, there are many circumstances in which it is not desirable for a user to have control of at least some of the buttons on the controller. For example in an advertising environment, it may not be desirable for a user to have control of the “power” button on an IR remote because a display that is off results in lost advertising time and revenue.

In addition, in such an advertising environment more than one set-top box (STB) can be associated with a TV Wall. It is not practical to place all the STB units in a location at which all of the STB units can be controlled by a single IR remote. Conversely, it may not be desirable for a single IR remote to control more than one display in the TV Wall yet the respective STB units of various displays can be within the operating range of a single IR remote.

Even further, a content presentation environment (e.g., a home theater system or advertising environment) can include various components of a single vendor or components from various vendors. For example, in the advertising environment described above, a TV Wall can include displays of more than one model from a single vendor or can include displays from various vendors. In some instances, it can be desirable to control all of the components of a content presentation environment with a single remote despite the components being different types of components from a single vendor or being components from various vendors.

In addition, there are instances in such systems in which it can be desirable to assign different functions to the various buttons of an IR remote for increasing the functionality of such an IR remote.

As such, what is needed is a means for controlling and interpreting IR remote control signals in an integrated content presentation environment.

### SUMMARY OF THE INVENTION

Embodiments of the present invention address the deficiencies of the prior art by providing a method, apparatus and system for controlling networked devices using non-specific IR remote control codes.

In various embodiments of the present invention, a networked bypass controller of the present invention receives IR codes transmitted from an IR transmitter (often a handheld device) and the controller can be configured to either process the IR codes normally, or to perform actions, such as translation or association of the codes with stored function commands, on the IR codes transmitted. The networked bypass controller of the present invention can then send the resulting commands to one or more playout devices over a network.

For example, in one embodiment of the present invention, a method of the present invention includes receiving an infrared signal, using a predetermined association list, associating the received infrared signal with a control command, and communicating the control command for affecting a change in at least one playout device.

In an alternate embodiment of the present invention, an system of the present invention includes a remote controller for communicating infrared control signals, a playout device controller for receiving the infrared control signals and communicating the received infrared control signals to at least one of a playout device and a bypass controller, and a bypass controller for receiving the communicated infrared control signals and, using a predetermined association list, associating the received infrared signal with a control command and for communicating the control command to the playout device controller for affecting a change in at least one associated playout device.

It should be noted that the codes sent by the IR transmitter (remote controller) and communicated to the networked bypass controller of the present invention need not be from the same command set as the commands sent to some of the networked devices. In accordance with various embodiments of the present invention, an IR transmitter from one vendor is capable of controlling devices from any collection of vendors. In accordance with various embodiments of the present invention, the control functions can exceed the specific command capabilities of the actual IR code command set and can be remapped to different or broader roles.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising;

FIG. 3 depicts a high level block diagram of a networked IR bypass system in accordance with an embodiment of the present invention; and

FIG. 4 a flow diagram of a method for networked IR bypass in accordance with one embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for controlling networked devices using non-specific IR remote control codes. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in substantially any networked content presentation environment such as a networked home theater environment.

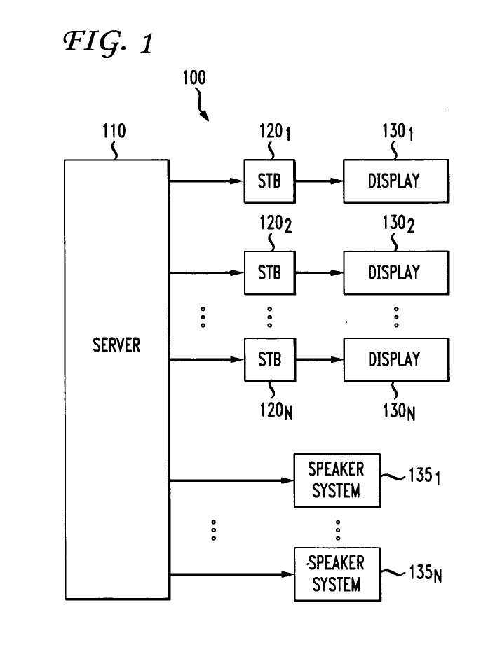

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ, and other receiving devices, such as audio output devices (illustratively speaker systems) 135₁-135ₙ. Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

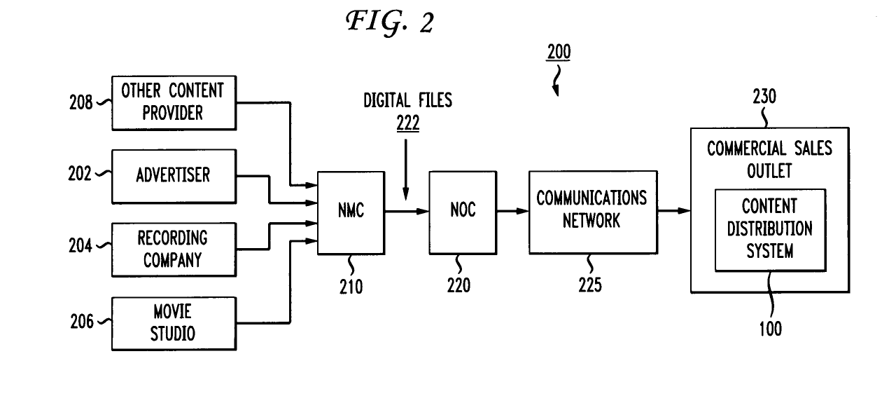

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 of FIG. 1 is capable of receiving content (e.g., distribution packs) and, accordingly, distribute them in-store to the various receivers such as the set-top boxes 120 and displays 130 and the speaker systems 135. That is, at the content distribution system 100, content is received and configured for streaming. The streaming can be performed by one or more servers configured to act together or in concert. The streaming content can include content configured for various different locations or products throughout the sales outlet 230 of FIG. 2 (e.g., store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

In networked content presentation systems and environments such as a networked home theater environment or the content distribution system 100 and in-store advertising network 200 described above, a remote controller, such as an IR remote, can be used to control the various components of such systems. For example, in the content distribution system 100 of FIG. 1, an IR remote can be used to control the receiving devices such as the tuning/decoding means (illustratively set-top boxes (STBs)) 120₁-120ₙ, and respective displays 130₁-130ₙ for each of the set-top boxes 120₁-120ₙ, and other receiving devices, such as the audio output devices (illustratively speaker systems) 135₁-135ₙ.

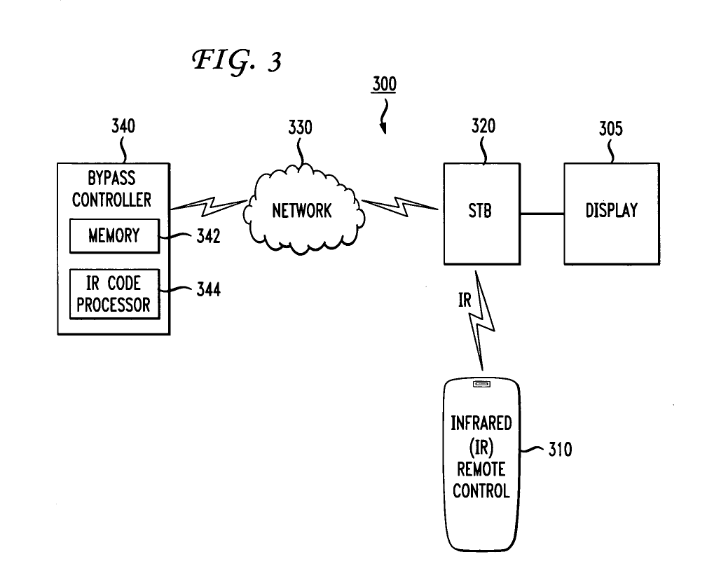

For example, FIG. 3 depicts a high level block diagram of a networked IR bypass system in accordance with an embodiment of the present invention. In the networked IR bypass system 300, an IR transmitter, illustratively an IR remote controller 310, communicates a control signal to a device controller, illustratively a set-top box (STB) 320 for a display 305. In accordance with embodiments of the present invention, the STB 320 receives IR codes transmitted from an IR remote controller 310 and the STB 320 can be configured to either process the IR codes normally, or to ‘bypass’ the codes by sending them to a configured network destination instead. For example, in the networked IR bypass system 300 of FIG. 3, the STB 320 is operably connected to a network 330. In one embodiment of the present invention, the network 330 can comprise a TCP/IP network using wireless or Ethernet communications. The IR codes received by the STB 320 can be communicated by the STB 320 to a controller through the network 330.

That is, as depicted in FIG. 3, a bypass controller 340 is also in communication with the network 330. In one embodiment, the bypass controller 340 comprises a general purpose computer or server, provided for performing the inventive concepts of the present invention. In accordance with embodiments of the present invention, the controller can comprise a remote server, such as the NMC 210 or the NOC 220, or a local server such as the server 110 of the content distribution system 100 of FIG. 1. For example and as depicted in FIG. 3, the bypass controller 340 can include a memory 342 for storing a list of IR codes that can possibly be received and corresponding responses (control commands) associated with those IR codes that should be communicated to one or more device controllers in response to the received IR code(s) and an IR code processor 344 for, using the stored association list, associating a received infrared signal with a response (control command) to be communicated to a playout device or a controller of the playout device for affecting an intended response or change in the playout device.

The bypass controller 340 of FIG. 3 stores and executes application software capable of evaluating, reconfiguring and performing or not performing the actions indicated by the IR codes transmitted by the STB 320 to the bypass controller 340 via the network 330. The bypass controller 340 acts to filter the codes, taking action on some or none of them and even converting the IR codes to perform alternative actions. In addition, the bypass controller 340 can be configured to asynchronously send IR codes to the STB 320 over the network 330 and the STB 320 can be configured to either ignore the commands from the bypass controller 340 or to respond as if the commands had been transmitted from the IR remote controller 310.

For example in the embodiment of FIG. 3, the IR remote controller 310 can be provided with limited functionality. That is, if, for example, the STB 320 and display 305 of FIG. 3 were part of a retail advertising network, user control of the display 305 via the IR remote controller 310 can be limited such that a user is not able to negatively affect the advertising capabilities of such a system. For example, in one embodiment of the present invention, a channel change button of the IR remote controller 310 can be configured to enable a user to switch between provided media clips and/or video and audio streams communicated to the display 305 from the server 110/bypass controller 340.

More specifically, in one embodiment of the present invention, an IR code associated with the depression of a channel change button of the IR remote controller 310 can be communicated to the STB 320. The STB 320 then communicates the IR code via the network 330 to the bypass controller 340, at which the controller interprets the IR code to effectively select a different available advertising channel to be communicated to the STB 320 and displayed on the display 305 instead of actually changing the channel of the display 305. For example, in one embodiment of the present invention, the server 110 can provide two or more video and/or audio channels that can be selected to be displayed on the display 130. For example, the various channels can include sport programming (e.g., basketball games, football games, etc.), movie programming, information programming (e.g., news shows, weather channels, etc.) and the like. As such, a user would be able to, using the channel up and channel down buttons of the IR remote controller 310, switch between the various channels of content provided by the server 110.

In accordance with various embodiments of the present invention, the bypass controller 340 can send commands in response to the received IR codes to one or more device controllers. For example, the bypass controller 340 can haves stored in an included memory 342 a list of IR codes that can possibly be received and corresponding responses associated with those IR codes that should be communicated to one or more device controllers in response to the received IR code(s).

For example, in one embodiment of the present invention, an IR bypass system in accordance with the present invention can be implemented in a TV Wall of a retail environment. More specifically, the content distribution system 100 of FIG. 1 can be a content distribution system comprising a TV Wall. More specifically, a content distribution system as depicted in FIG. 1 can include a plurality of receiving devices such as tuning/decoding means (illustratively set-top boxes (STBs)) 120₁-120ₙ, and a respective display 130₁-130ₙ for each of the set-top boxes 120₁-120ₙ. The STBs 120 and displays 130 can comprise a TV Wall for advertising purposes. In such an embodiment, a single IR remote controller can be configured to control one or more of the displays 130. In addition, in such an embodiment, an associated STB does not necessarily apply the IR code action from the IR remote controller. Instead, the STB sends received IR codes to the above described controller of the present invention. The controller can either do nothing with the command, translates the command to some other command, or relay the command back the original STB 120 and/or to one or more of the other STBs 120.

For example, in the embodiment of the present invention described above (e.g., a TV Wall), a user can press a channel change button on an associated IR remote controller and an associated channel change IR code can be communicated to at least one of the STBs 120. The STB 120 can then communicate the IR code to a bypass controller 340 of the present invention as described with respect to FIG. 3. The bypass controller 340 can translate the IR code received to mean that an alternate media clip and/or video and audio stream should be selected by the STB 120 for display on one or more displays 130 in the TV Wall associated with the STB 120 that communicated the IR code to the bypass controller 340. Alternatively, the bypass controller 340 can translate the IR code received to cause all of the STBs 120 associated with the displays 130 to select an alternate media clip and/or video and audio stream for affecting a channel change. That is, in such an embodiment, a channel change button of the IR remote controller can be configured to enable a user to switch between provided media clips and/or video and audio streams communicated to the displays 130 from the bypass controller 340.

Such associations or translations by the bypass controller 340 can be predetermined and stored in a memory (not shown) of the bypass controller 340 of the present invention. That is, in accordance with various embodiments of the present invention, a controller of the present invention stores a command set (e.g., list of associations) of processes for IR codes capable of being received from an IR remote controller. If so configured, the controller does not necessarily apply the IR code action, instead, the controller refers to a predetermined list of associations for a received IR code and performs an action associated with the received IR code.

In accordance with an embodiment of the present invention, the translation or association aspects performed by the bypass controller of the present invention, can be implemented for applying vendor specific commands via specific communications channels. For example, in one embodiment of the present invention, the IR bypass functions of the present invention can be used for controlling playout functionality of a content playout device(s) using established HDMI communication and vendor specific commands as taught and claimed in a commonly owned Provisional Patent Application Ser. No. 60/872,908, filed Dec. 5, 2006 and entitled “METHOD, APPARATUS AND SYSTEM FOR DISPLAY CONTROL AND OPTIMIZATION”, later filed as a PCT application serial number PCT/US2007/024811, which is herein incorporated by reference in its entirety.

Even further, the concepts of the present invention can be implemented for using an IR remote controller to control the function(s) of a control device/receiver of a different model or of a different vendor than the IR remote controller is intended to control. More specifically, in various embodiments of the present invention, an IR remote controller communicates an IR code to a control device/receiver of, for example, a display device. The control device/receiver communicates the IR code to a bypass controller of the present invention as described above (e.g., bypass controller 340 of FIG. 3). The controller receives the IR code communicated by the control/device receiver and refers to stored data that associates the received the IR code with an appropriate command intended for a device to be controlled by the control device/receiver that communicated the IR code. In addition, the controller of the present invention, can further have stored, a list of all devices in a system (i.e., a list of all of all of the models and makers of the control devices/receivers and displays of a TV Wall). A controller of the present invention can then, if configured to do so, translate the received IR code into a respective, appropriate command for each of the control devices/receivers and associated playout devices for affecting the IR code functionality for each of the control devices/receivers and associated playout devices.

More specifically, in various embodiments of the present invention, a bypass controller of the present invention can receive an IR code from an IR remote controller and translate the received IR code to control any model device or device from any vendor despite whether or not the IR remote controller is compatible with the intended device by referring to a stored associations list which translates a received IR code into an appropriate signal to be communicated by the bypass controller of the present invention to an intended device for affecting an appropriate response from the device to the IR code. That is, it should be noted that codes sent by the IR remote controller (e.g., transmitter) and bypassed to a bypass controller of the present invention need not be from the same command set as the commands sent to a networked devices because control features can be remapped to different or broader commands by referring to predetermined associations in accordance with the present invention.

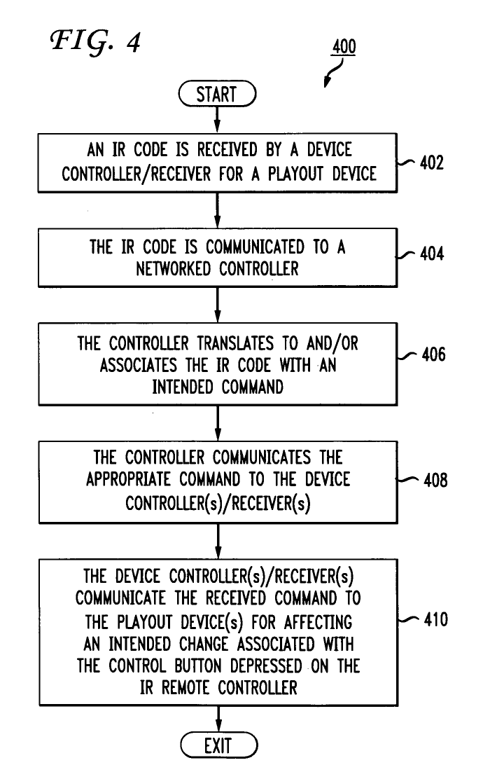

FIG. 4 a flow diagram of a method for networked IR bypass in accordance with one embodiment of the present invention. The method 400 of FIG. 4 begins in step 402 at which an IR code is received by a device controller/receiver for a playout device (e.g., display, speaker), the IR code being generated by a control button depression on an IR remote controller. The method 400 then proceeds to step 404.

At step 404, the IR code is communicated to a networked controller of the present invention, such as the bypass controller 340 of FIG. 3. The method 400 then proceeds to step 406.

At step 406, the controller, using a predetermined association list, translates to and/or associates the IR code with an intended command to be communicated to the device controller/receiver for affecting an intended change in one or more intended playout devices as described in at least the embodiments of the present invention presented above. The method 400 then proceeds to step 408.

At step 408, the controller communicates an appropriate command to the device controller(s)/receiver(s) for the playout device(s). The method 400 then proceeds to step 410.

At step 410, the device controller(s)/receiver(s) communicate the received command to the playout device(s) for affecting an intended change associated with the control button depressed on the IR remote controller. The method 400 can then be exited.

Having described various embodiments for a method, apparatus and system for controlling networked devices using non-specific IR remote control codes (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method comprising the steps of:
receiving an infrared signal;
using a predetermined association list, associating the received infrared signal with a control command; and
communicating the control command for affecting a change in at least one playout device.

2. The method of claim 1, wherein said infrared signal is received by a control unit for said at least one playout device.

3. The method of claim 2, wherein said control unit communicates said received infrared signal to a bypass controller.

4. The method of claim 3, wherein said infrared signal is communicated over a network.

5. The method of claim 3, wherein said bypass controller associates the received infrared signal with a predetermined action associated with the received infrared signal.

6. The method of claim 5, wherein said bypass controller communicates a control command to said control unit for affecting said predetermined action in said at least one playout device.

7. The method of claim 1, wherein said infrared signal is transmitted from a remote controller.

8. The method of claim 1, wherein said at least one playout device comprises a device for presenting retail advertising.

9. The method of claim 1, wherein said received infrared signal, via said association list, can affect changes in playout devices of at least one of different manufacturers and models.

10. An apparatus, comprising:
a memory for storing a list of IR codes that can possibly be received by the apparatus and corresponding control commands associated with the IR codes; and
an IR code processor for, using the list, associating a received infrared signal with a control command and communicating the control command to at least one playout device controller for affecting a change in at least one playout device.

11. The apparatus of claim 10, wherein said apparatus comprises a bypass controller.

12. The apparatus of claim 10, wherein said at least one playout device controller comprises a set-top box and said at least one playout device comprises a display.

13. The apparatus of claim 10, wherein said list of IR codes and corresponding control commands limits the functionality of a remote controller, which is a source of the infrared signals.

14. The apparatus of claim 10, wherein said at least one playout device controller comprises playout device controllers of at least one of different manufacturers and different models.

15. The apparatus of claim 10, wherein said at least one playout device comprises playout devices of at least one of different manufacturers and different models.

16. A system, comprising:
an IR transmitter for communicating infrared control signals;
at least one playout device controller for receiving said infrared control signals and communicating said received infrared control signals to at least one of a playout device and a bypass controller; and
a bypass controller for receiving said communicated infrared control signals and, using a predetermined association list, associating the received infrared signal with a control command and for communicating the control command to the at least one playout device controller for affecting a change in at least one associated playout device.

17. The system of claim 16, wherein said system comprises an in-store advertising network.

18. The system of claim 16, wherein said system comprises a home entertainment network.

19. The system of claim 16, wherein said at least one playout device comprises playout devices of different models or from different manufacturers.

20. The system of claim 16, wherein said at least one playout device controller comprises playout device controllers of different models or from different manufacturers.

21. The system of claim 16, wherein a single playout device controller is associated with more than one playout devices.

22. The system of claim 16, wherein a single playout device can be controlled by more than one playout device controller.
